(19) United States
(12) Patent Application Publication
(10) Pub. No.: US 2009/0171671 A1
(43) Pub. Date: Jul. 2, 2009

(54) APPARATUS FOR ESTIMATING SOUND QUALITY OF AUDIO CODEC IN MULTI-CHANNEL AND METHOD THEREFOR

(76) Inventors: Jeong-Il Seo, Daejon (KR); Seung-Kwon Beack, Seoul (KR); In-Seon Jang, Daejon (KR); Kyeong-Ok Kang, Daejon (KR); Jin-Woo Hong, Daejon (KR); In-Yong Choi, Seoul (KR); Sang-Bae Chon, Seoul (KR); Koeng-Mo Sung, Seoul (KR)

Correspondence Address: LADAS & PARRY LLP, 224 SOUTH MICHIGAN AVENUE, SUITE 1600, CHICAGO, IL, 60604, US

(21) Appl. No.: 12/278,033

(22) PCT Filed: Feb. 5, 2007
(86) PCT No.: PCT/KR2007/000610

§ 371 Date: Dec. 12, 2008

Related U.S. Application Data
(60) Provisional application No. 60/833,622, filed on Jul. 27, 2006.

(30) Foreign Application Priority Data
Feb. 3, 2006 (KR) 10-2006-0010642
Sep. 12, 2006 (KR) 10-2006-0088192

(51) Int. Cl. G10L 21/00

(52) U.S. Cl. 704/500

(57) ABSTRACT

There is an apparatus for evaluating the audio quality of a multi-channel audio codec, including: a preprocessing unit for synthesizing binaural signals based on multi-channel audio signals transmitted through a multi-channel of a multi-channel audio reproduction system; an output variable calculator for calculating an interaural cross-correlation coefficient distortion (IACCDist) and other output variables of the binaural signals; and an artificial neural network circuit for outputting a grade of the perceived quality based on the interaural cross-correlation coefficient distortion (IACCDist) and other output variables calculated in the output variable calculator.

### TECHNICAL FIELD

The present invention relates to an apparatus and method for estimating the auditory quality in a multi-channel audio codec; and, more particularly, to an apparatus and method for estimating the audio quality of a multi-channel audio codec by measuring a degree of degradation in the perceived audio quality of an audio signal which is encoded and decoded by the multi-channel audio codec with respect to an original signal before the compression.

### BACKGROUND ART

A study on a method for evaluating the audio quality of a monaural or a stereo channel audio signal codec has been made for a long period of time up to now. There is a proposal recommended by ITU Radiocommunication Sector (ITU-R)(see ITU-R Recommendation BS. 1387-1, “Method for objective measurements of perceived audio quality”, International Telecommunication Union, Geneva, Switzerland, 1998).

The proposal, however, has a limitation that it cannot be used in an intermediate/low performance audio codec and a multi-channel audio codec.

On the other hand, for a multi-channel audio codec that is the object of evaluation, its development discussion is actively underway in the MPEG standard group (ISO/IEC/JTC1/SC29/WG11). There are the publications developed by various institutions. The audio quality evaluation of these codecs has been made by the listening subjective evaluation method based on the MUSHRA technique (ITU-R Recommendation BS. 1534-1, “Method for the subjective Assessment of Intermediate Sound Quality (MUSHRA)”, International Telecommunication Union, Geneva, Switzerland, 2001). There are the publications on the listening evaluation results of diverse codecs employing the above method (see ISO/IEC JTC1/SC29/WG11(MPEG), N7138, “Report on MPEG Spatial Audio Coding RMO Listening Tests”, and ISO/IEC JTC1/SC29/WG11(MPEG), N7139, “Spatial Audio Coding RMO Listening Test Data”).

In evaluating the audio quality of the multi-channel audio codec, however, such a method is very subjective, wherein a listener directly listens to an audio signal, evaluates its audio quality, and conducts a statistical process thereon. Therefore, there is an urgent need for a method for performing an audio quality evaluation through a consistent audio quality measurement or predicting the result of the audio quality evaluation, without doing the listening evaluation and statistical process by the listener for the audio quality evaluation of the multi-channel audio codec.

### DISCLOSURE

### Technical Problem

An embodiment of the present invention is directed to providing an apparatus and method for evaluating the auditory quality in a multi-channel audio codec by means of the objective and consistent measurement of the audio signals, multi-channel in order to predict the subjective evaluation result produced by listeners in a multi-channel audio reproduction environment.

The other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided an apparatus for evaluating the audio quality of a multi-channel audio codec including: a preprocessing unit for synthesizing binaural signals based on multi-channel audio signals transmitted through a multi-channel of a multi-channel audio reproduction system; an output variable calculator for calculating an interaural cross-correlation coefficient distortion (IACCDist) and other output variables of the binaural signals; and an artificial neural network circuit for outputting a grade of the perceived quality based on the interaural cross-correlation coefficient distortion (IACCDist) and other output variables calculated in the output variable calculator.

In accordance with another aspect of the present invention, there is provided a method for evaluating the audio quality of a multi-channel audio codec, including the steps of: synthesizing binaural signals based on multi-channel audio signals transmitted through channels L, R, C, LS and RS of a multi-channel audio reproduction system; calculating an interaural cross-correlation coefficient distortion (IACCDist) and other conventional output variables of the binaural signals; and outputting a grade of the audio quality based on the calculated interaural cross-correlation coefficient distortion (IACCDist) and the output variables.

### Advantageous Effects

As described above and will be given below, the present invention evaluates the audio quality of a multi-channel audio codec through the objective and consistent measurement of the audio quality, without performing the listening tests and statistical analysis. Accordingly, the present invention has an advantage in that a developer or user can simply evaluate the auditory quality of the multi-channel audio codec which is developed by the developer or used by the user, without a burden on time or economy.

In addition, the present invention has another advantage that the objective quality evaluation results of the multi-channel audio codec can be used as the to verify the subjective evaluation results from the listening tests.

### BRIEF DESCRIPTION OF THE DRAWINGS

FIG. 1 is a diagram illustrating a structure of a multi-channel audio reproduction system recommended by ITU-R, to which the present invention is applied.

FIG. 2 is a diagram illustrating a structure of an apparatus for evaluating the audio quality of a multi-channel audio codec in accordance with a preferred embodiment of the present invention.

FIG. 3 is a diagram describing an embodiment of a total sound transfer path in accordance with the present invention.

FIG. 4 is a diagram describing the operation of one example of the preprocessing unit of the binaural signal synthesis in accordance with the present invention.

FIG. 5 is a flowchart illustrating a method for evaluating the audio quality of the multi-channel audio codec in accordance with another preferred embodiment of the present invention.

### BEST MODE FOR THE INVENTION

The advantages, features and aspects of the invention will become apparent from the following description of the embodiments with reference to the accompanying drawings, which is set forth hereinafter, so that a person skilled in the art will easily carry out the invention. Further, in the following description, well-known arts will not be described in detail if it seems that they could obscure the invention in unnecessary detail. Hereinafter, preferred embodiments of the present invention will be described in detail with reference to the accompanying drawings.

In general, a multi-channel audio has 6 channels (or 5.1 channel) such as front speakers (LF (left front) and RF (right front)), a center speaker (C), an intermediate and low sound channel (LFE: low frequency effect), and rear speakers ((LS (left surround) and RS (right surround)). Among these, since the LFE is not actually used in many cases, only the 5 channel channels of the front speakers (LF and RF), the center speaker (C), and the rear speakers (LS and RS) are used.

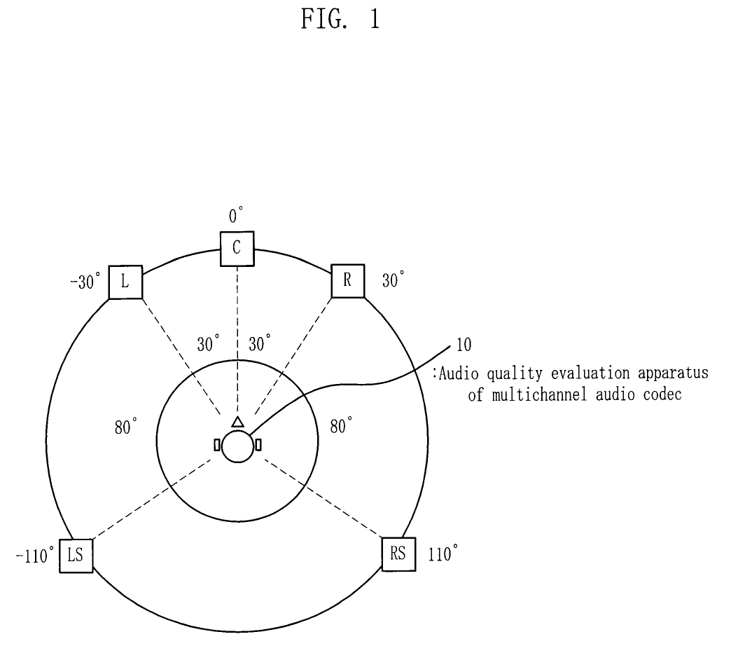

FIG. 1 is a diagram illustrating a structure of a multi-channel audio reproduction system recommended by ITU-R, to which the present invention is applied.

As shown in FIG. 1, in the multi-channel audio reproduction system recommended by the ITU-R, the 5 channel speakers are arranged on the line of one circle centering around a listener 10, wherein the front left and the right speakers L and R and the listener 10 forms a regular triangle. The distance between the center speaker C in the front and the listener 10 is equal to that between the front left and the right speakers L and R. And, the rear left and the right speakers LS and RS are placed on the concentric circle of 100 to 120 degrees with respect to the front which is 0 degree.

The reason that the reproduction system should conform to the standard arrangement recommended by the ITU-R is that the intended audio quality (the best audio quality) can be obtained by doing so because most of sources were edited/recorded based on the arrangement standard.

The present invention substitutes the listener 10 of the multi-channel audio reproduction system recommended by the ITU-R by an audio quality evaluation apparatus of the multi-channel audio codec which evaluates the audio quality by measuring impulse responses of multi-channel audio signals from the 5 channel speakers L, R, C, LS and RS by using an binaural microphone that simulates the body (the head and upper half).

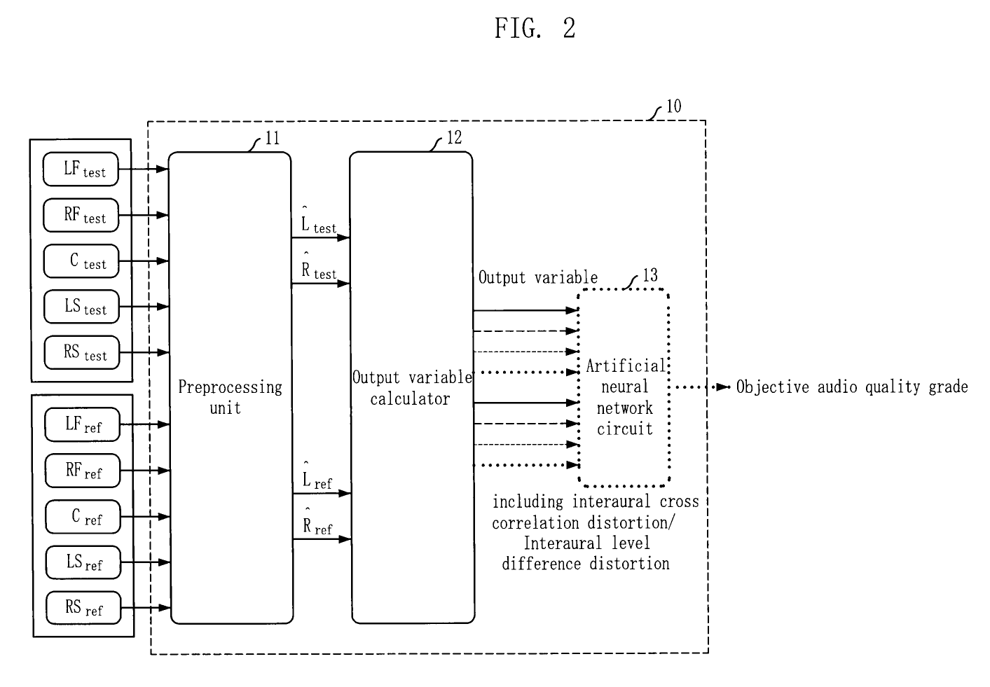

FIG. 2 is a diagram illustrating a structure of an apparatus for evaluating the audio quality of a multi-channel audio codec in accordance with a preferred embodiment of the invention.

As shown in FIG. 2, the audio quality evaluation apparatus 10 of the multi-channel audio codec includes a preprocessing unit 11 for synthesizing binaural signals ^{\hat{L}}^{_{ref}}, ^{\hat{R}}^{_{ref}}, ^{\hat{L}}^{ₜₑₛₜ}, and ^{\hat{R}}^{ₜₑₛₜ} based on multi-channel audio signals transmitted through the channels L, R, C, LS and RS of a standard multi-channel audio reproduction system recommended by the ITU-R, an output variable calculator 12 for calculating an interaural cross-correlation coefficient distortion (IACCDist), an interaural level difference distortion (ILDDist) and, and other conventional output variables, and an artificial neural network circuit 13 for outputting a grade of the audio quality on the basis of the interaural cross-correlation coefficient distortion (IACCDist), the interaural level difference distortion (ILDDist) and the other output variables provided from the output variable calculator 12.

Here, the interaural cross-correlation coefficient (IACC) represents the maximum value of the normalized cross correlation function between the left ear input and the right ear input, and the interaural level difference ILD denotes the ratio of intensity of signals between the left ear input and the right ear input.

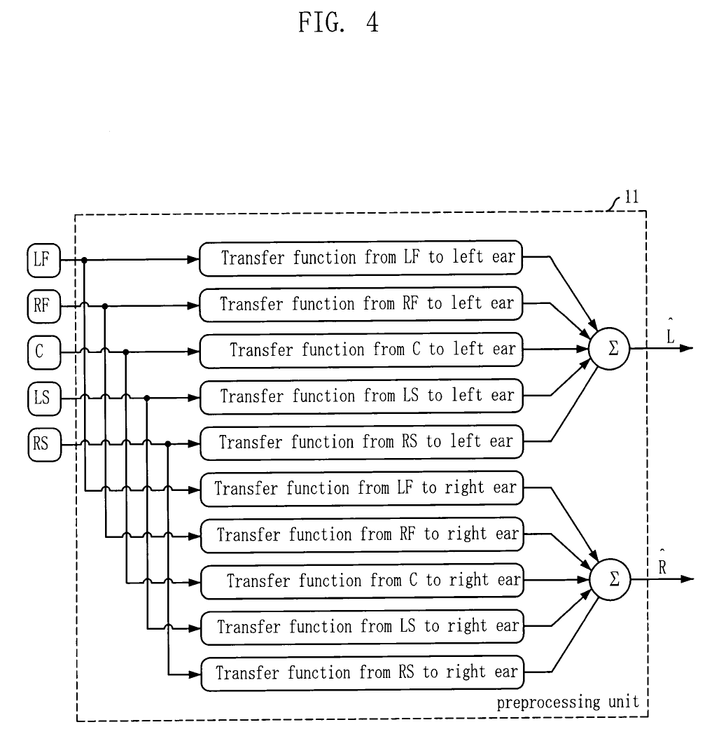

The following is a brief explanation on the operation of each of the components of the audio quality evaluation apparatus of the multi-channel audio codec according to the invention. Five channel signals of sound sources which are encoded and decoded by the multi-channel audio codec to be evaluated are indicated by ^{LF}^{ₜₑₛₜ}, ^{RF}^{ₜₑₛₜ}, ^{C}^{ₜₑₛₜ}, ^{LS}^{ₜₑₛₜ} and ^{RS}^{ₜₑₛₜ}, and Five channel signals of their original sound sources are denoted by ^{LF}^{_{ref}}, ^{RF}^{_{ref}}, ^{C}^{_{ref}}, ^{LS}^{_{ref}} and ^{RS}^{_{ref}}. First, the total ten signals of ^{LF}^{ₜₑₛₜ}, ^{RF}^{ₜₑₛ}, ^{C}^{ₜₑₛₜ}, ^{LS}^{ₜₑₛₜ}, ^{RS}^{ₜₑₛₜ}, ^{LF}^{_{ref}}, ^{RF}^{_{ref}}, ^{C}^{_{ref}}, ^{LS}^{_{ref}} and ^{RS}^{_{ref}} are inputted to the preprocessing unit 10. The preprocessing unit 10 convolves head related impulse responses of corresponding azimuth angles—that simulate the transfer function of the sound propagation path including the body (head and torso) of a listener—to the 5 channel test signals and 5 channel reference signals, and sums up the convolutions, to thereby calculate the binaural signals ^{\hat{L}}^{_{ref}}, ^{\hat{R}}^{_{ref}}, ^{Î}^{_{.test}}, and ^{\hat{R}}^{ₜₑₛₜ}. The purpose of this process is the simulation of the acoustical environment in the audio reproduction layouts, and the process is illustrated as a block diagram in FIG. 4.

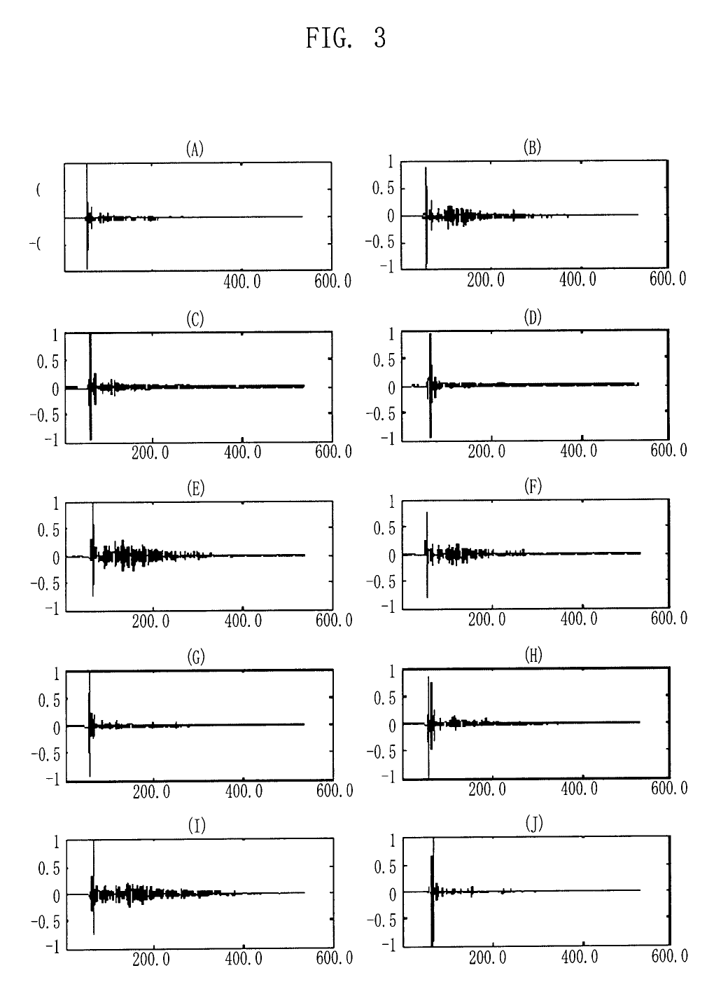

At this time, the total number of the sound transfer paths is ten, due to the five locations of loudspeakers and two ears of a listener, which may be represented by graphs as depicted in FIG. 3.

The output variable calculator 12 calculates the interaural cross-correlation coefficient distortion (IACCDist) and the interaural level difference distortion (ILDDist). Those two novel variables, IACCDist and ILDDist, mirror degradations in the attributes of spatial quality. The calculated interaural cross-correlation coefficient distortion (IACCDist), the interaural level difference distortion (ILDDist), and the other possible variables are then provided to the artificial neural network circuit 13. The artificial neural network circuit 13 outputs a grade of the audio quality based on the interaural cross-correlation coefficient distortion (IACCDist), the interaural level difference distortion (ILDDist), and the other possible variables provided from the output variable calculator 12.

Here, the output variable calculator 12 calculates the interaural cross-correlation coefficient distortion (IACCDist) and the interaural level difference distortion (ILDDist) by using the following equations (1) and (2). The interaural level difference (ILD) of an uncompressed original audio signal is named ^{ILD}^{_{ref}} and the interaural level difference (ILD) of the audio signal which is encoded and decoded by the multi-channel audio codec under test is named ^{ILD}^{ₜₑₛₜ}. Also, the interaural cross-correlation coefficients (IACC) may be named in the similar way. For the calculation of interaural cross-correlation coefficient (IACC) and the interaural level difference (ILD), the binaural signals are converted to time-frequency segment signals with the 75% overlapped time frames (of the length that equivalent to 50 ms for IACC, and of the length that equivalent to 10 ms for ILD) and 24 auditory critical bands filter-banks. Among these, the interaural level difference distortion ILDDist for a k'th frequency band of an n'th time frame is represented as ^{ILDist[k,n]}.

ILDDist[k.n]=w[k.n]|ILDₜₑₛₜ[k.n]−ILD_{ref}[k.n]| Eq. (1)

wherein ^{ILDDist} denotes the interaural level difference distortion, and w[k,n] is a weighted function that is decided depending on the range of the critical band, which reflects the intensity level of a time-frequency segment and auditory sensitivity to the interaural level difference ILD.

Meanwhile, to acquire the interaural level difference distortion ^{ILDDist} of the entire auditory band in the n'th time frame, an average is taken for the entire frequency bands as following:

$$ILDDist [ n ] = \frac{1}{Z} {{\sum }_{k = 0}}^{Z - 1} ILDDist [ k , n ] \qquad Eq . ( 2 )$$

By averaging again the ILDDist[n] for the entire time frames, the interaural level difference distortion ^{ILDDist} of the multi-channel audio codec can be calculated, and the interaural cross-correlation coefficient (IACC) can also be calculated in the same way. At this time, the interaural cross-correlation coefficient distortion IACCDist is named ^{ICCDist}; and since the interaural level difference distortion ^{ICCDist} and the interaural cross correlation distortion have the high cross correlation with the audio quality evaluation (subjective evaluation) result of the multi-channel audio codec by the listener, the output variable calculator 12 can regard these as the output variables. These values and the other possible output variables are inputted to the artificial neural network circuit 13, to thereby output the one-dimensional grade of the audio quality with the objectivity and consistency.

FIG. 4 is a diagram describing the operation of one example of the preprocessing unit of the audio quality evaluation apparatus in accordance with the invention.

As shown in FIG. 4, the preprocessing unit 11 of the audio quality evaluation apparatus 10 converts an impulse response of each sound transfer path which is measured by using an interaural microphone that simulates the body (the head and upper half) of the standard multichannel audio reproduction system recommended by the ITU-R into a transfer function, and sums up the transfer functions, to thereby calculate the interaural input signals ^{\hat{L}}^{_{ref}}, ^{\hat{R}}^{_{ref}}, ^{\hat{L}}^{ₜₑₛₜ} and ^{\hat{R}}^{ₜₑₛₜ}.

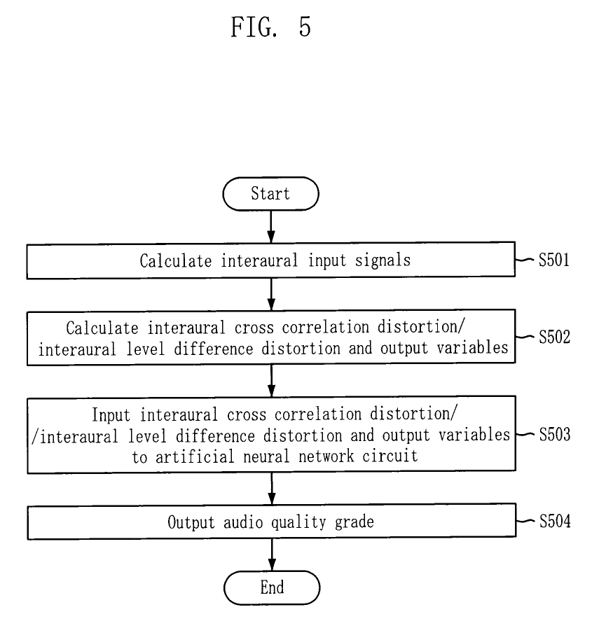

FIG. 5 illustrates a flowchart of a method of evaluating the audio quality of the multi-channel audio codec in accordance with another preferred embodiment of the present invention.

First of all, the preprocessing unit 11 of the audio quality evaluation apparatus 10 of the multi-channel audio codec converts an impulse response of each of a sound source which is encoded and decoded by the multi-channel audio codec and an original sound source into a transfer function, and sums up the transfer functions, to thereby calculate the interaural input signal ^{\hat{L}}^{_{ref}}, ^{\hat{R}}^{_{ref}}, ^{\hat{L}}^{ₜₑₛₜ} and ^{\hat{R}}^{ₜₑₛₜ} (501).

Thereafter, the output variable calculator 12 calculates the interaural cross-correlation coefficient distortion (IACCDist) and the interaural level difference distortion (ILDDist) from the time-frequency segments of the binaural signals ^{\hat{L}}^{_{ref}}, ^{\hat{R}}^{_{ref}}, ^{\hat{L}}^{ₜₑₛₜ} and ^{\hat{R}}^{ₜₑₛₜ} provided by the preprocessing unit 11, and calculates other possible output variables (502) also from the binaural signals. The calculated interaural cross-correlation coefficient distortion (IACCDist), the interaural level difference distortion (ILDDist), and the other possible output variables are then applied to the artificial neural network circuit 13 (503).

The artificial neural network circuit 13 outputs a grade of the audio quality based on the inputted output variables including interaural cross-correlation coefficient distortion (IACCDist), the interaural level difference distortion (ILDDist), and the other possible output variables (504).

The method of the present invention as mentioned above may be implemented by a software program that is stored in a computer-readable storage medium such as CD-ROM, RAM, ROM, floppy disk, hard disk, optical magnetic disk, or the like. This process may be readily carried out by those skilled in the art; and therefore, details of thereof are omitted here.

While the present invention has been described with respect to the particular embodiments, it will be apparent to those skilled in the art that various changes and modifications may be made without departing from the spirit and scope of the invention as defined in the following claims.

1-12. (canceled)

13. An apparatus for evaluating the audio quality of a multi-channel audio codec, comprising:
a preprocessing unit for synthesizing binaural signals based on multi-channel audio signals transmitted through a multichannel of a multi-channel audio reproduction system;
an output variable calculator for calculating an interaural cross-correlation coefficient distortion (IACCDist) and other output variables of the binaural signals; and
an artificial neural network circuit for outputting a grade of the audio quality based on the interaural cross-correlation coefficient distortion (IACCDist) and the other output variables calculated in the output variable calculator.

14. The apparatus of claim 13, wherein the preprocessing unit converts multi-channel audio signals into the binaural signals by the means of convolving head and torso related impulse responses of each sound transfer path corresponding multi-channel signals, and summing up the transferred signals.

15. The apparatus of claim 14, wherein the multi-channel audio signals include a sound source which is encoded and decoded by a multi-channel audio codec, and an original sound source.

16. The apparatus of claim 15, wherein the output variable calculator calculates the interaural cross-correlation coefficient distortion (IACCDist) of the binaural signals by using difference between interaural cross-correlation coefficient (IACC) of the original sound source and interaural cross-correlation coefficient (IACC) of the audio signal which is encoded and decoded by the multi-channel audio codec.

17. The apparatus of claim 16, wherein the interaural cross-correlation coefficient (IACC) represents cross correlation of signals being inputted to both ears (interaural).

18. An apparatus for evaluating the audio quality of a multi-channel audio codec, comprising:
a preprocessing unit for synthesizing binaural signals based on multi-channel audio signals transmitted through a multi-channel of a multi-channel audio reproduction system;
an output variable calculator for calculating an interaural level difference distortion (ILDDist) and other output variables of the binaural signals; and
an artificial neural network circuit for outputting a grade of the audio quality based on the interaural level difference distortion (ILDDist) and the other output variables calculated in the output variable calculator.

19. The apparatus of claim 18, wherein the preprocessing unit converts multichannel audio signals into the binaural signals by the means of convolving head and torso related impulse responses of each sound transfer path corresponding multi-channel signals, and summing up the transferred signals.

20. The apparatus of claim 19, wherein the multi-channel audio signals include a sound source which is encoded and decoded by a multi-channel audio codec, and an original sound source.

21. The apparatus of claim 20, wherein the output variable calculator calculates the interaural level difference distortion (ILDDist) of the binaural signals by using difference between interaural level difference (ILD) of the original sound source and interaural level difference (ILD) of the audio signal which is encoded and decoded by the multi-channel audio codec.

22. The apparatus of claim 21, wherein the interaural level difference (ILD) represents ratio of energies of signals being inputted to both ears (interaural).

23. A method for evaluating the audio quality of a multi-channel audio codec, comprising the steps of:
synthesizing binaural signals based on multi-channel audio signals transmitted through channels L, R, C, LS and RS of a multi-channel audio reproduction system;
calculating an interaural cross-correlation coefficient distortion (IACCDist) and other output variables of the binaural signals; and
outputting a grade of the audio quality based on the calculated interaural cross-correlation coefficient distortion (IACCDist) and the output variables.

24. The method of claim 23, wherein the multi-channel audio signals include a sound source which is encoded and decoded by a multi-channel audio codec, and an original sound source.

25. The method of claim 24, wherein the output variable calculating step calculates the interaural cross-correlation coefficient distortion (IACCDist) by using difference between interaural cross-correlation coefficient (IACC) of the original sound source and interaural cross-correlation coefficient (IACC) of the audio signal which is encoded and decoded by the multi-channel audio codec.

26. The method of claim 25, wherein the interaural cross-correlation coefficient (IACC) represents cross correlation of signals being inputted to both ears (interaural).

27. A method for evaluating the audio quality of a multi-channel audio codec, comprising the steps of:
synthesizing binaural signals based on multi-channel audio signals transmitted through channels L, R, C, LS and RS of a multi-channel audio reproduction system;
calculating an interaural level difference distortion (ILDDist) and other output variables of the binaural signals; and
outputting a grade of the audio quality based on the calculated interaural level difference distortion (ILDDist) and the output variables.

28. The method of claim 27, wherein the multi-channel audio signals include a sound source which is encoded and decoded by a multi-channel audio codec, and an original sound source.

29. The method of claim 28, wherein the output variable calculating step calculates the interaural level difference distortion (ILDDist) by using difference between interaural level difference (ILD) of the original sound source and interaural level difference (ILD) of the audio signal which is encoded and decoded by the multi-channel audio codec.

30. The method of claim 29, wherein the interaural level difference (ILD) represents ratio of energies of signals being inputted to both ears (interaural).
